(19) United States
(12) Patent Application Publication
(10) Pub. No.: US 2024/0099200 A1
(43) Pub. Date: Mar. 28, 2024

(54) METHOD FOR TREATING SEED PRODUCTION PLANTS WITH SUPPLEMENTAL FAR-RED LIGHT

(71) Applicant: NUNHEMS B.V., Nunhem (NL)

(72) Inventor: Frank MILLENAAR, Nunhem (NL)

(21) Appl. No.: 18/275,378

(22) PCT Filed: Jan. 25, 2022
(86) PCT No.: PCT/EP2022/051615

§ 371 Date: Aug. 1, 2023

(30) Foreign Application Priority Data
Feb. 2, 2021 (EP) 21154676.7

(51) Int. Cl. A01G 7/04

(52) U.S. Cl. CPC A01G 7/045

(57) ABSTRACT

The present invention relates to a method for treating a seed production plant of a day-neutral plant species comprising subjecting said seed production plant to supplemental far-red light. The present invention further provides the use of far-red light irradiation of a seed producing plant for improving the quality of the plant seeds produced by said seed production plant.

### FIELD OF THE INVENTION

The present invention relates to the field of plant seed production. More specifically, the present invention provides a method for treating a seed production plant of a day-neutral plant species comprising subjecting said seed production plant to supplemental far-red light. The present invention further provides the use of far-red light irradiation of a seed producing plant for improving the quality of the plant seeds produced by said seed production plant.

### BACKGROUND

In modern agriculture plant seeds are often produced by seed production plants that are specifically grown with the purpose of producing seeds instead of the ordinary crop. One of the advantages of specifically growing plants for seed production is that the growth conditions can be optimized for this purpose; see e.g. Seed production principles and practices (1997) Mc Donald and Copeland published by Chapman & Hall, New York.

Plant growth conditions can be more specifically regulated when the seed production plants are grown in a controlled environment such as a cultivation tunnel, a glass greenhouse or even a climate chamber. However, such controlled cultivation environments lead to considerably higher costs when compared to seed production plants grown under uncontrolled conditions such as in an open field. It is therefore important to maximize seed yields for seed production plants grown under controlled conditions, while maintaining or even improving the quality of the produced seed. This is often challenging since improvements in seed yield may have a negative effect on seed quality. There is a constant need to improve the seed yield of seeds produced by seed production plants for plant cultivation such as vegetable crops, while maintaining or even improving the quality of plant seeds produced.

### SUMMARY OF THE INVENTION

The present invention provides a method for treating a seed production plant of a day-neutral plant species comprising subjecting said seed production plant to supplemental far-red light.

The present invention further provides a method for producing plant seeds comprising growing fruit on a seed production plant that is subjected to supplemental far-red light and obtaining the plant seeds from the ripened fruit, wherein said seed production plant is of a day-neutral plant species.

The present invention further provides a method for improving the quality of plant seeds produced by a seed production plant comprising growing said plant in the presence of an effective amount of supplemental far-red light, preferably after fertilization and/or during fruit development, wherein said seed production plant is of a day-neutral plant species.

The present invention further provides a method for growing plant seeds comprising growing a seed production plant in the presence of an effective amount of supplemental far-red light, preferably after fertilization and/or during fruit development, wherein said seed production plant is of a day-neutral plant species.

The present invention further provides the use of far-red light irradiation of a seed producing plant of a day-neutral plant species for improving the quality of the plant seeds produced by said seed production plant.

### BRIEF DESCRIPTION OF THE FIGURES

FIG. 1: the amount of seeds per fruit in control conditions and from plants grown with additional far-red light. Data of 5 hybrids.

FIG. 2: The percentage usable transplants from seeds that has been harvested from plants that were grown in control conditions or with the addition of far-red light. Data of 11 hybrids.

FIG. 3: Additional usable transplants from far-red (Y-axes) compared to the control conditions (X-axes). Data extracted from FIG. 2.

FIG. 4: The amount of seeds per fruit from plants in the control conditions or with the addition of far-red for two genotypes.

FIG. 5: The percentage of usable transplants from hybrid seeds that was produced in control conditions or with the addition of far-red.

FIG. 6: Seedling vitality (usable transplant percentage) of a representative cucumber hybrid variety produced under different PSS values.

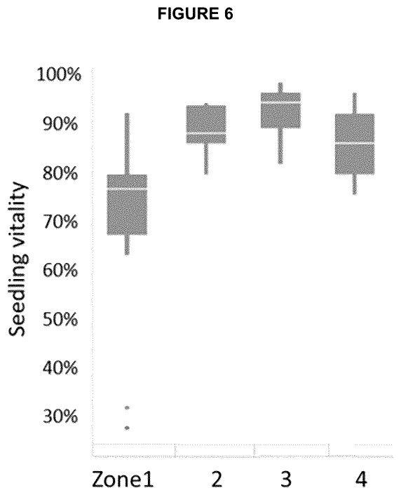

### DETAILED DESCRIPTION OF THE INVENTION

### General Definitions

As used herein, the term “plant” preferably includes the whole plant, including different developmental stages, such as seedlings, immature and mature, etc. When “seeds of a plant” are referred to, these either refer to seeds from which the plant can be grown or to seeds produced on the plant, after fertilization. Which meaning is used is evident from the context.

“Plant variety” is a group of plants within the same botanical taxon of the lowest grade known, which (irrespective of whether the conditions for the recognition of plant breeder's rights are fulfilled or not) can be defined on the basis of the expression of characteristics that result from a certain genotype or a combination of genotypes, can be distinguished from any other group of plants by the expression of at least one of those characteristics, and can be regarded as an entity, because it can be multiplied without any change. Therefore, the term “plant variety” cannot be used to denote a group of plants, even if they are of the same kind, if they are all characterized by the presence of one or two loci or genes (or phenotypic characteristics due to these specific loci or genes), but which can otherwise differ from one another enormously as regards the other loci or genes.

The term “cultivar” (or “cultivated” plant) is used herein to denote a plant having a biological status other than a “wild” status, which “wild” status indicates the original non-cultivated, nondomesticated, or natural state of a plant or accession, and the term cultivated does not include such wild, or weedy plants. The term cultivar does include material with good agronomic characteristics, such as breeding material, research material, breeding lines, elite breeding lines, synthetic population, hybrid, founder stock/base population, inbred lines, cultivars (open pollinated of hybrid cultivar), segregating population, mutant/genetic stock, and advanced/improved cultivar. The so-called heirloom varieties or cultivars, i.e. open pollinated varieties or cultivars commonly grown during earlier periods in human history and often adapted to specific geographic regions, are in one aspect of the invention encompassed herein as cultivated plants. In one embodiment the term cultivar also includes landraces, i.e. plants (or populations) selected and cultivated locally by humans over many years and adapted to a specific geographic environment and sharing a common gene pool.

The term “food” is any substance consumed to provide nutritional support for the body. It is usually of plant or animal origin, and contains essential nutrients, such as carbohydrates, fats, proteins, vitamins, or minerals. The substance is ingested by an organism and assimilated by the organism's cells in an effort to produce energy, maintain life, or stimulate growth. The term food includes both substance consumed to provide nutritional support for the human and animal body.

The term “seed production plant” refers to a plant that is specifically grown with the purpose of producing plant seeds for subsequent sowing. Accordingly, the produce of a seed production plant is preferably not used as food.

The term “day-neutral plant species” refers to a plant species that is capable of flowering regardless of day length.

A “plant line” or “breeding line” refers to a plant and its progeny. As used herein, the term “inbred line” refers to a plant line which has been repeatedly selfed and is nearly homozygous. Thus, an “inbred line” or “parent line” refers to a plant which has undergone several generations (e.g. at least 4, 5, 6, 7 or more) of inbreeding, resulting in a plant line with a high uniformity.

“Selfing” refers to self-pollination of a plant, i.e., the transfer of pollen from the anther to the stigma of the same plant.

“Crossing” or cross-pollination refers to the mating of two parent plants, e.g. pollinating a

female parent line with pollen of a male parent line.

“F1, F2, F3, etc. ” refers to the consecutive related generations following a cross between two parent plants or parent lines. The plants grown from the seeds produced by crossing two plants or lines is called the F1 generation. Selfing the F1 plants results in the F2 generation, etc.

A “female plant” is to be understood herein as a plant that is pollinated by a male parent.

A “male plant” is to be understood herein as a plant of which the pollen is used to pollinate a female plant.

“F1 hybrid” plant (or “F1 hybrid seed”) is the generation obtained from crossing two inbred parent lines. Thus, F1 hybrid seeds are seeds from which F1 hybrid plants grow. F1 hybrids are more vigorous and higher yielding, due to heterosis. Inbred lines are essentially homozygous at most loci in the genome.

“Pollination” is the process by which pollen is transferred to the stigma of the flower, thereby enabling fertilization and reproduction.

“Emasculation” is understood herein as the removal of the anthers to prevent self-pollination.

“Sowing” refers to the process of placing the seed in an appropriate medium for germination, so that it is able to grow into a plant. The medium can e.g. encompass soil, various types of rockwool, (liquid) culture media, etc.

A “seed treatment formulation” is understood herein to be a formulation comprising at least one active ingredient such as, but not limited to, a pesticide, a seed nutrient or a seedling disease treatment agent. Preferably, said at least one active ingredient is a pesticide such as an insecticide, a fungicide, an antimicrobial, an acaricide, a nematicide, a fungicide and/or a combination hereof. Seed treatment formulations are understood to possibly comprise a combination of different active ingredients. Such formulation is preferably added to the seed in the form of a film coating, which is a uniform, dust-free, water permeable film, evenly covering the surface of all individual seeds. The seed treatment formulation can be added directly on the seed or in a pelleting mixture as defined herein. Besides active ingredient(s), the seed treatment formulation generally also contains other ingredients such as water, glue (typically a polymer), filler materials, pigments and certain additives to improve particular properties of the coating. A variety of techniques and machines exist to apply film coatings, and many of these can also be used or adapted for seed pelleting. Manufacturers of seed treatment machines are, for example, Gustafson Equipment, Satec and SUET. Techniques and machines vary in the method of applying the seed treatment mixture to the seed and the blending process (Jeffs, K. A. and Tuppen, R J. 1986. Applications of pesticides to seeds. Part 1: Requirements for efficient treatment of seeds. In: Seed treatment. Ed: Jeffs, K. A.). The mixture, for example, can be added by means of a spinning disc atomizer or spreading brushes. The seeds and the mixture can be blended by means of an auger, in a drum, or in rotating troughs. If the amount of film coating mixture added is low and can be absorbed by the seed itself with only a slight (typically less than 1%) increase in seed moisture content, no additional drying step is necessary. This principle is called self-drying (Black et al., 2006. The encyclopedia of seeds. Science, technology and uses). Otherwise, a drying powder (such as talc) could be added, or an additional drying step is necessary. This step could be integrated in the equipment for film coating, such as in the SUET rotary seed treater with integrated fluid bed dryers. Some SATEC batch coaters are equipped to be connected with drying air also.

“Seed pelleting” is a technique that is primarily intended to change the natural shape and size of the raw seed. These techniques in general comprise adding a pelleting mixture in order to change seed size and/or shape for creating round or rounded seed shapes which are easily sown with modern sowing machines.

A “pelleting mixture” contains at least glue and filler material. The latter could be, for example, clay, mica, chalk or cellulose. In addition, certain additives can be included to improve particular properties of the pellet. A seed treatment formulation as defined herein can be added directly into the pelleting mixture. It is also encompassed that a seed treatment formulation is added on the outside of the pellet, for instance between two layers of pelleted seed, or directly on the seed before the pelleting material is added. Also, more than 1 film coating layer of seed treatment formulation can be incorporated in a single pellet.

The term “seed quality” is understood herein as an indication for the potential of plant seeds to develop into a useful plant. Accordingly, seed quality can also be expressed in terms including, but not limited to, the germination ratio and the useable transplant ratio as further described herein. Accordingly, the term “improved seed quality” as used herein preferably refers to an improvement in the germination ratio and/or an improvement in the usable transplant ratio when comparing at least two different seed samples.

“Seed yield per plant” or “average seed yield per plant” or “average total seed yield per plant” is understood herein to be the total average number of seeds (immature, less mature and/or mature) produced per plant when a plurality of plants are grown and pruned in the same way according to the method of the invention. In one aspect the average total seed yield per plant can be established by determining the average total number of fruits produced per plant (excluding eventual parthenocarpic fruits) and multiplying this number with the average number of seeds per fruit. The average seed number per fruit can be determined as soon as the seeds have formed, so e.g. fruits can be harvested when the fruits are immature, half mature, mature or overmature, as the seed number doesn't change once the seeds have formed. The average number of seeds per fruit can be determined e.g. by counting all of the seeds of all fruits produced by a plant (excluding eventual parthenocarpic fruits), and by doing this for a number of plants e.g. at least three, four or more plants grown in the same way, to calculate the average seed number per fruit.

The term “germination ratio” refers to the number of seeds germinated as per total number of seeds planted. The germination ratio is an indicator for the quality of a population of seeds. Equally, the germination percentage can be calculated as the number of seeds germinated as per total number of seeds planted multiplied by 100.

The term “usable transplant ratio” refers to the number of usable transplants as per total number of seeds planted. The usable transplant ratio is a further indicator for the quality of a population of seeds. Equally, the usable transplant percentage can be calculated as the number of usable transplants as per total number of seeds planted multiplied by 100.

The term “fruit” refers to the seed-bearing structure in flowering plants. The term fruit as used herein accordingly not only encompasses fleshy fruits that are suitable for consumption, but also the seed-bearing structures that as such are not suitable for consumption e.g. as produced by leafy vegetables such as spinach and lettuce.

“Harvest” is understood herein to be the collection of fruits and/or seeds developed in the fruits.

“Mature seeds” refers to seeds that have reached the optimal development stage for the use of said seeds for sowing and which preferably result in the highest germination ratio and/or the highest useable transplants ratio.

“Less mature seeds” and “immature seeds” refers to seeds that are not yet fully mature in their development and have not reached their final mature seed colour but are e.g. white (immature) or have various degrees of pigment but to a lesser extent than the fully mature seeds.

The term “far-red light” refers to a range of light at the extreme red end of the visible spectrum. Preferably, “far-red light” is light having a peak wavelength in a range of 700 to 800 nm. The term “peak wavelength in a range” accordingly may also include light emitters that emit light outside the indicated range in addition to the peak emission at the indicated wavelength range. Preferably, the far-red light is light having a peak wavelength of at least 700 nm, more preferably of at least 710 nm and most preferably of at least 720 nm, and at most 800 nm, more preferably at most 790 nm, even more preferably at most 780, at most 770 nm, at most 760 nm and most preferably at most 750 nm.

The term “supplemental far-red light” refers to far-red light that is applied, e.g. to a plant, in addition to the already present ambient light such as the available sunlight and/or artificial light.

The term “artificial far-red light source” refers to any man-made light source that is emitting far-red light. Examples of such artificial far-red light source include incandescent light sources, gas discharge light sources and LED light sources. An “incandescent light source” is an electric light source comprising a wire filament to which an electric current is applied causing the filament to glow, thereby emitting light over a broad wavelength spectrum. Incandescent light sources have several disadvantages and accordingly are not commonly used in horticulture. The term “gas discharge light source” refers to an artificial light source that generate light by sending an electric discharge through an ionized gas. Gas discharge light sources useful for irradiation of plants in horticulture are well-known in the art. The term “LED light source” relates to a light source that wherein Light Emitting Diodes are used for illumination. LED light sources useful for irradiation of plants in horticulture are well-known in the art.

The term “phytochrome stationary state (PSS) value” refers to the ratio of the concentration of the Pᵣ isoform of phytochrome to the total concentration of both isoforms under constant irradiation by a light source (Sager et al. (1988) Trans. ASAE31, 1882-1889. doi:10.13031/2013.30952). Phytochrome exists in two states, or isoforms. In its ground state (identified as Pᵣ), phytochrome strongly absorbs red light, and so appears turquoise-blue in concentrated solution in vitro. When it absorbs a red photon, however, it changes its physical shape to form its physiologically active state P_{fr}. In doing so, its peak spectral absorptance shifts towards the far-red, with a concentrated solution of phytochrome appearing more greenish in colour. When phytochrome is in its P_{fr} state, it may absorb a far-red photon and change once again into its Pᵣ state. This bi-stable behaviour makes phytochrome an ideal biochemical switch, with the P_{fr} isoform serving as the signalling state to the plant.

“Carrot” or “carrot plant” refers herein to plants of the species Daucus carota. The most commonly eaten part of a carrot is the root. “Cultivated Carrot” refers to plants of Daucus carota i.e. varieties, breeding lines or cultivars of the species D. carota, cultivated by humans and having good agronomic characteristics.

“Corn salad” (or lamb's lettuce), Valerianella locusta (L.) Betcke (synonym formerly Valerianella olitoria (L.) Poll; fam. Valerianaceae) is a leafy vegetable crop cultivated in several European countries, such as the Netherlands, Italy, Germany and France, as well as in parts of North America and Australia. Wild V. locusta is native to Europe, temperate western Asia and parts of North-Africa. Of almost 80 species classified in the genus Valerianella, only V. locusta is cultivated for human consumption. The leaves or whole plants or whole plantlets are used in fresh salads. Production takes place in both glasshouse cultivation and field cultivation, optionally under covers (e.g. plastic tunnels or shade nettings).

“Cucurbits” or “cucurbit plants” or “plants of the family Cucurbitaceae ” are plants of the botanical family Cucurbitaceae, i.e. any plant of the family Cucurbitaceae that preferably are suitable for cultivation. The cucurbits consist of about 965 species in around 95 genera, of which the most important to humans are the genera Cucumis (cucumber and melon), Citrullus (watermelon), and Cucurbita (squash, pumpkin, zucchini and gourd).

“Cucumber” (Cucumis sativus var. sativus L.) is an important vegetable crop worldwide. It belongs to the family Cucurbitaceae. It is thought to originate from South East Asia from wild ancestors with small, bitter fruits, such as Cucumis sativus var. hardwickii. The cultivated cucumber genome has seven pairs of chromosomes (n=7) and a haploid genome size of about 367 Mb (Megabases) with an estimated total of about 26,682 genes.

“Melon” or “melon plant” refers to plants of Cucumis melo L. e.g. varieties, breeding lines or cultivars, cultivated by humans and having good agronomic characteristics, preferably producing edible and marketable fruits of good size and quality and uniformity. Such cultivated melon plants may for example be further classified as C. melo var. cantalupensis, C. melo var. inodorous and C. melo var. reticulatus.

“Watermelon” or “watermelon plant” or refers to plants of Citrullus lanatus ssp. vulgaris, preferably varieties, breeding lines or cultivars, cultivated by humans and having good agronomic characteristics, especially producing edible and marketable fruits of good size and quality and uniformity.

“Cucurbita pepo plant” or “Cucurbita pepo” refers to plants of C. pepo, preferably varieties, breeding lines or cultivars, cultivated by humans and having good agronomic characteristics, especially producing edible and marketable fruits of good size and quality and uniformity. Examples of Cucurbita pepo plant are breeding lines or varieties or cultivars of pumpkin (C. pepo subsp. pepo), squash, zucchini or courgette, marrows, etc.

“Solanaceous plants” or “plants of the family Solanaceae” are plants of the botanical family Solanaceae, i.e. any plant of the family Solanaceae, including wild solanaceous plants and cultivated solanaceous plants. The botanical family Solanaceae consists about 98 genera of which the genera Solanum and Capsicum are the commercially most relevant as they comprise many domesticated species that are widely cultivated and used as food crops with high economic importance.

The genus Capsicum consists of 20 to 27 species, five of which are domesticated: C. annuum, C. baccatum, C. chinense, C. frutescens, and C. pubescens. Phylogenetic relationships between species have been investigated using bio-geographical, morphological, chemosystematic, hybridization, and genetic data. Fruits of Capsicum, often named as “peppers” or “pepper fruits”, can vary tremendously in colour, shape, and size both between and within species. Chemosystematic studies helped distinguish the difference between varieties and species.

Pepper plants of the species Capsicum annuum L. plants are herbaceous plants of the family Solanaceae that are of particular relevance in the context of the present invention. Capsicum annuum plants reach about 0.5-1.5 meters (about 20-60 inches). Single white flowers bear the pepper fruit which is green when unripe, changing principally to red, although some varieties may ripen to brown or purple. While the species can tolerate most climates, they are especially productive in warm and dry climates. Cultivated plants of the species Capsicum annuum include different types of peppers, such as bell peppers, cayenne peppers, paprika, and jalapeños. “Capsicum annuum chromosome 3” refer to the Capsicum annuum chromosome 3, as known in the art (see Capsicum annuum cv CM334 genome chromosomes (release 1.55) and Capsicum annuum UCD10X genome chromosomes (v1.0) and Capsicum annuum zunla genome chromosomes (v2.0) “Orthologous chromosome 3” refers to the corresponding chromosome of relatives of Capsicum annuum.

The genus Solanum consists of about 1330 species, including the highly important food crops tomato (S. lycopersicum), eggplant (S. melongena) and potato (S. tuberosum).

Solanum lycopersicum plants or “tomato plants” are further herbaceous plants of the family Solanaceae that are of particular relevance in the context of the present invention. Tomato plants are perennial in their native habitat but cultivated as an annual. Cultivated tomato plants typically grow to 1-3 meters (3-10 ft) in height. Tomato fruits are botanically berry-type fruits, they are considered culinary vegetables. Fruit size varies according to cultivar, with a width range of about 1-10 cm (about 0.5-4 inches). Solanum lycopersicum is also known as Lycopersicon lycopersicum (L.) H. Karst. or Lycopersicon esculentum Mill. The term “cultivated tomato plant” or “cultivated tomato” refers to plants of Solanum lycopersicum, e.g. varieties, breeding lines or cultivars of the species S. lycopersicum, cultivated by humans and having good agronomic characteristics. Tomato is diploid and has/have 12 pairs of chromosomes, numbered 1 to 12. In one embodiment, the term “tomato plants” further encompasses plants (or plant parts) of the species Solanum habrochaites and/or plants of the species Solanum pimpinelifolium, which are particularly useful as a rootstock for a tomato plant.

Solanum melongena plants or “eggplant” or “aubergine plants” are further herbaceous plants of the family Solanaceae. The egg-shaped, glossy, dark purple to white fruit has white flesh with a meaty texture. S. melongena plants grow about 40-150 cm (about 1.3-5 ft) tall, with large, coarsely lobed leaves that are about 10-20 cm (about 3-8 in) long and about 5-10 cm (about 2-4 in) broad.

“Average” refers herein to the arithmetic mean.

It is understood that comparisons between different growth conditions involves growing a number of plants of a line (or variety) (e.g. at least 5 plants, preferably at least 10 plants per line) under the relevant test conditions and control conditions and the determination of differences, preferably statistically significant differences, between the plants when grown under the relevant growth conditions. Preferably the plants are of the same line or variety.

In this document and in its claims, the verb “to comprise” and its conjugations is used in its non-limiting sense to mean that items following the word are included, but items not specifically mentioned are not excluded. In addition, reference to an element by the indefinite article “a” or “an” does not exclude the possibility that more than one of the elements is present, unless the context clearly requires that there be one and only one of the elements. The indefinite article “a” or “an” thus usually means “at least one”.

### Method for Treating Seed Production Plants

The present invention provides a method for treating a seed production plant of a day-neutral plant species comprising subjecting said seed production plant to supplemental far-red light. In one aspect, the present invention provides a method for treating a seed production plant of a day-neutral plant species comprising subjecting said seed production plant to an effective amount of supplemental far-red light when growing fruit (i.e. after fertilization of the seed production plant).

It has been previously described that plants are capable of reacting to the lighting conditions in their growth environment through phytochromes, which are a class of plant photoreceptors which are particularly sensitive to the ratio of red to far-red light as comprised in the light spectrum. In a natural growth environment, a low red to far-red light ratio is typically caused when a plant is growing in the shadow of sunlit plant leaves. Such a low red to far-red light condition results in a low phytochrome stationary state (PSS) and subsequently to a shade avoidance response of the plant. Typical shade avoidance responses of plants include one or more of plant elongation, altered flowering time, increased apical dominance and altered partitioning of resources; see e.g. Zhang et al. (2019) Journal of integrative Agriculture 18(1) 62-69 DOI: 10.1016/S2095-3119(18)62130-6. Also, an increase of the red to far-red ratio above the value typical for unobstructed sunlight leads to a response in the plant. For instance, Kalaitzoglou et al. (2019) Frontiers in Plant Science DOI: 10.3389/fpls.2019.00322 describe that increasing the red to far-red ratio of artificial LED light to above the red to far-red ratio of sun light negatively influences the growth and early fruit production of young tomato plants.

Only little information is available on the effect of exposing seed production plants, such as parental plants used in F1 hybrid seed production, to supplemental far-red light on the quality of the subsequently obtained seeds in terms of germination ratio and/or the useable transplant rate. Contreras et al. (2009) HortScience DOI 10.21273/HORTSCI.44.1.130 evaluated the hypothesis that lettuce seed germinability and longevity are affected by the red to far-red light ration and which the seeds mature. This study reported that subjecting the seed production plants to supplemental far-red light leads to a dramatically reduced germination ratio under certain germination conditions. Contreras et al. accordingly propose to produce lettuce seeds under environments with higher red to far-red ratio to obtain seeds that are able to germinate rapidly and uniformly in a broader range of field conditions.

The inventors found that for day-neutral plant species the quality of the seeds can be improved, preferably in combination with an increase of the seed yield, by subjecting a seed production plant to supplemental far-red light, preferably when growing fruit (e.g. after fertilization). Particularly, not only the number of seeds per fruit, but also the percentage of usable transplants that can be obtained from the seeds is improved when the seed production plant of a day-neutral plant species has been subjected to supplemental far-red light. This finding is surprising in view of the teachings of e.g. Contreras et al. (loc. cit.) which reported that in lettuce subjecting the seed production plant to supplemental far-red light leads to a reduced seed quality, particularly a reduced germination ratio of the seeds produced.

The seed production plant according to the present invention may be grown in soil (full soil or in pots), perlite bags, on an aerated nutrient solution, or on rockwool, or hydroponically (e.g., on sawdust or rockwool, while irrigated with a nutrient solution as known in the art) (e.g., referred is to Jovicich et al., 1999; Nielsen and Veirskov, 1988; Maboko and Ciloane, 2012. In one embodiment the seed production plants are grown on rockwool. In another embodiment the seed production plants are grown in the full soil, e.g. in the field.

Plants may be grown under any conditions suitable for growing the seed production plant which are well-known in the art; see e.g. Seed production principles and practices (1997) Mc Donald and Copeland published by Chapman & Hall, New York. In one aspect the plants are grown in controlled environment conditions, such as a tunnel, a greenhouse, such as a glass green house, or a climate chamber. Thus, in one aspect the seed production plants are grown under standard controlled environment growth conditions that is specifically adapted for the plant species of the seed production plant. Such controlled environment growth conditions are well known in the art. Particularly, the controlled environment growth conditions comprise an average growth temperature in the range of 16-25° C., more preferably of 17-24° C., 18-23° C. or most preferably of 19-21° C. Preferably, night temperature is lower than the day temperature. Preferably, the controlled environment growth conditions further comprise a controlled atmosphere in which the humidity and/or the carbon dioxide (CO₂) content is adjusted and/or regulated. Preferably, the controlled environment growth conditions further comprise an atmosphere having an average CO₂ content in the range of 300-1200 ppm, more preferably in the range of 400-1100 ppm, 500-1000 ppm, or most preferably 600-800 ppm. The controlled environment growth conditions preferably further comprise controlled irrigation, controlled nutrient distribution, controlled shading and/or controlled ventilation.

The climate may be a controlled climate, i.e. a climate controlled in the sense that temperature, humidity and radiation are tightly regulated by means known in the art.

Plants can be grown at various densities. So for example in the method of the invention the seed production plant has a planting density of 1.0 1.5 2.0, 2.1, 2.2, 2.3, 2.4, 2.5, 2.6, 2.7, 2.8, 2.9, 3.0, 3.1, 3.2, 3.3, 3.4 or 3.5, 4.0, 4.5 or 5.0 stems/m², more preferably 2.4 to 3.2 plants/m², most preferably 2.6 to 3.0 stems/m².

Accordingly, the seed production plant is subjected to supplemental far-red light, preferably when growing fruit, for instance after fertilization. This means that the seed production plant may be subjected to supplemental far-red light at any time, for instance before fertilization, during fertilization and after fertilization up to harvesting the seeds, e.g. by separating the fruits from the seed production plant. In one aspect, the method according to the present invention comprises subjecting the seed production plant to supplemental far-red light at any time between fertilization of the seed production plant and harvesting the seeds, e.g. by separating the fruits from the seed production plant. In one aspect, the method according to the present invention further comprises subjecting the seed production plant to supplemental far-red light before fertilization in addition to subjecting said seed production plant to supplemental far-red light during fruit development. In one aspect, the method according to the present invention further comprises subjecting the seed production plant to an effective amount of supplemental far-red light, for instance during fruit development and/or before fertilization as described herein.

In one aspect, the method of the present invention accordingly comprises subjecting the seed production plant to an effective amount of supplemental far-red light. The term “effective amount” in this context means that the supplemental far-red light is capable of achieving the desired effect of improving the seed quality of the seeds produced by a seed production plant, particularly improving the germination ratio and/or an improving the usable transplant ratio when compared to seeds produced by a seed production plant that is not subjected to supplemental far-red light. In one aspect, the seed production plant in the method of the present invention is exposed to supplemental far-red light resulting in a phytochrome stationary state (PSS) value of less than 0.88. As described herein, the PSS value refers to the ratio of the concentration of the ground state isoform of phytochrome to the total concentration of both the ground state isoform and the physiologically active state isoform under constant irradiation by a light source, which can be readily determined by methods known in the art, e.g. as described in the Examples. Preferably, the seed production plant is exposed to supplemental far-red light resulting in a PSS value of less than 0.87, less than 0.86, less than 0.85, less than 0.84, less than 0.83, less than 0.82, less than 0.81, less than 0.80, less than 0.79, less than 0.78, less than 0.76, less than 0.75, less than 0.74, or most preferably of less than 0.73. In one aspect, the supplemental far-red light in the method of the present invention originates from an artificial far-red light source having a peak wavelength in a range of 700 to 800 nm. Preferably, the artificial far-red light source as used in the method of the present invention has a peak wavelength in a range of 700 to 790 nm, 700 to 780 nm, 700 to 770 nm, 700 to 760 nm, 700 to 750 nm, 700 to 780 nm, 700 to 780 nm, 710 to 800 nm, 710 to 790 nm, 710 to 780 nm, 710 to 770 nm, 710 to 760 nm, 710 to 750 nm, 720 to 800 nm, 720 to 790 nm, 720 to 780 nm, 720 to 770 nm, 720 to 760 nm, or 720 to 750 nm.

In one aspect, the supplemental far-red light in the method of the present invention originates from an artificial far-red light source emitting far-red light with an intensity of 5-200 μmol/m²/s. Preferably, the artificial far-red light source as used in the method of the present invention is emitting far-red light with an intensity of 10-200 μmol/m²/s, 15-200 μmol/m²/s, 20- 200 μmol/m²/s, 25-200 μmol/m²/s, 30-200 μmol/m²/s, 35-200 μmol/m²/s, 40-200 μmol/m²/s, 50-200 μmol/m²/s, 60-200 μmol/m²/s, 70-200 μmol/m²/s, 80-200 μmol/m²/s, 90-200 μmol/m²/s, 5-190 μmol/m²/s, 10-190 μmol/m 2 /s, 15-190 μmol/m²/s, 20-190 μmol/m²/s, 25-190 μmol/m²/s, 30-190 μmol/m²/s, 35-190 μmol/m²/s, 40-190 μmol/m²/s, 50-190 μmol/m²/s, 60-190 μmol/m²/s, 70-190 μmol/m²/s, 80-190 μmol/m²/s, 90-190 μmol/m²/s, 100-190 μmol/m²/s, 5-180 μmol/m²/s, 10-180 μmol/m²/s, 15-180 μmol/m²/s, 20-180 μmol/m²/s, 25-180 μmol/m²/s, 30-180 μmol/m²/s, 35-180 μmol/m²/s, 40-180 μmol/m²/s, 50-180 μmol/m²/s, 60-180 μmol/m²/s, 70-180 μmol/m²/s, 80-180 μmol/m²/s, 90-180 μmol/m²/s, 5-170 μmol/m²/s, 10-170 μmol/m²/s, 15-170 μmol/m²/s, 20-170 μmol/m²/s, 25-170 μmol/m²/s, 30-170 μmol/m²/s, 35-170 μmol/m²/s, 40-170 μmol/m²/s, 50-170 μmol/m²/s, 60-170 μmol/m²/s, 70-170 μmol/m²/s, 80-170 μmol/m²/s, 90-170 μmol/m²/s, 5-160 μmol/m²/s, 10-160 μmol/m²/s, 15-160 μmol/m²/s, 20-160 μmol/m²/s, 25-160 μmol/m²/s, 30-160 μmol/m²/s, 35-160 μmol/m²/s, 40-160 μmol/m²/s, 50-160 μmol/m²/s, 60-160 μmol/m²/s, 70-160 μmol/m²/s, 80-160 μmol/m²/s, 90-160 μmol/m²/s, 5-150 μmol/m²/s, 10-150 μmol/m²/s, 15-150 μmol/m²/s, 20-150 μmol/m²/s, 25-150 μmol/m²/s, 30-150 μmol/m²/s, 35-150 μmol/m²/s, 40-150 μmol/m²/s, 50-150 μmol/m²/s, 60-150 μmol/m²/s, 70-150 μmol/m²/s, 80-150 μmol/m²/s, 90-150 μmol/m²/s, 5-140 μmol/m²/s, 10-140 μmol/m²/s, 15-140 μmol/m²/s, 20-140 μmol/m²/s, 25-140 μmol/m²/s, 30-140 μmol/m²/s, 35-140 μmol/m²/s, 40-140 μmol/m²/s, 50-140 μmol/m²/s, 60-140 μmol/m²/s, 70-140 μmol/m²/s, 80-140 μmol/m²/s, 90-140 μmol/m²/s, 5-130 μmol/m²/s, 10-130 μmol/m²/s, 15-130 μmol/m²/s, 20-130 μmol/m²/s, 25-130 μmol/m²/s, 30-130 μmol/m²/s, 35-130 μmol/m²/s, 40-130 μmol/m²/s, 50-130 μmol/m²/s, 60-130 μmol/m²/s, 70-130 μmol/m²/s, 80-130 μmol/m²/s, or 90-130 μmol/m²/s.

Artificial light sources that are useful in plant cultivation are well-known in the art and include halogen lamps, metal halide (MH) high-intensity discharge (HID) light sources and LED light sources. In one aspect, the artificial far-red light source in the method according to the present invention is a LED light source. In horticultural lighting LED-based light sources have several advantages including high energy efficiency, and relatively low costs. Furthermore, LED-based light sources may have spectral bandwidth characteristics which makes them particularly useful as a far-red light source.

In one aspect, the seed production plant in the method of the present invention is subjected supplemental far-red light for 1-20 hrs per day. Preferably, the seed production plant in the method of the present invention is subjected supplemental far-red light for 2-20 hrs per day, 3-20 hrs per day, 4-20 hrs per day, 5-20 hrs per day, 6-20 hrs per day, 7-20 hrs per day, 8-20 hrs per day, 1-19 hrs per day, 2-19 hrs per day, 3-19 hrs per day, 4-19 hrs per day, 5-19 hrs per day, 6-19 hrs per day, 7-19 hrs per day, 8-19 hrs per day, 1-18 hrs per day, 2-18 hrs per day, 3- 18 hrs per day, 4-18 hrs per day, 5-18 hrs per day, 6-18 hrs per day, 7-18 hrs per day, or most preferably 8-18 hrs per day.

The present invention may be useful for producing seeds of any day-neutral plant species, wherein the seeds are produced by a seed production plant. The present invention is particularly useful for treating seed production plants and/or for producing seeds, wherein the seed production plant is grown in controlled environment growth conditions. Accordingly, the present invention is particularly useful for producing seeds in a tunnel, in a (glass) green house or in a climate chamber. In one aspect, the seed production plant in the method of the present invention is a vegetable plant.

Preferably, the seed production plant in the method and the use of the present invention is a carrot, corn salad, cucumber, eggplant, melon, pepper, squash, tomato or watermelon plant. More preferably, the seed production plant in the method and the use of the present invention is cucurbit or solanaceous plant (e.g. a cucumber, melon, watermelon, pepper or tomato plant, preferably a cucumber plant or a tomato plant). Even more preferably, the seed production plant in the method and the use of the present invention is a solanaceous plant. Most preferably, the seed production plant in the method of the present invention is a tomato plant. Preferably, the seed production plant is not a wild plant. Accordingly, the seed production plant preferably produces cultivated plant seeds (i.e. plants seeds of a cultivated plant as defined herein).

It is understood that the method and the use as described herein are generally applied to a plurality of seed production plants, e.g. at least 10, 20, 30, 40, 50, 60, 70, 80, 100, 500, 1000, 2000, 3000, 4000, 5000, 6000, 7000, 8000, 9000, 10000 or more plants. It is understood that the plurality of seed production plants are of the same genotype, so when e.g. referring to a plurality of plants of an inbred parent line all plants are plants of the same inbred parent line.

The present invention is particularly useful for producing plant seeds produced by seed production plants that are specifically developed and grown with the purpose of producing seeds for sowing (i.e. not to be used as food). In one aspect, accordingly all seed production plants are of the same female parent line, preferably the same inbred female parent line. Likewise, it is understood that the male parent plant which was previously used for pollination of the female parent plant is of one genotype, e.g. of a male parent line, e.g. a male parent inbred line. In one aspect, the seed production plant in the method of the present invention is an inbred plant. In one aspect, the seed production plant of the present invention is an F1 hybrid parental line plant. In one aspect, the seed production plant is an emasculated plant. In one aspect, the seed production plant of the present invention is a male sterile plant. In one aspect, the plant seeds produced by the seed production plant according to the present invention are F1 hybrid plant seeds. Such F1 hybrid plants may have advantages such as improved uniformity, vitality and/or disease tolerance.

In one aspect the seed production plant according to the present invention is additionally subjected to supplemental light having a shorter wavelength than the supplemental far-red light. In one aspect, the seed production plant according to the present invention is subjected to supplemental far-red light for a longer time period than the supplemental light having a shorter wavelength than the supplemental far-red light. Preferably, the seed production plant according to the present invention is subjected to supplemental far-red light for a longer time period per day than the supplemental light having a shorter wavelength than the supplemental far-red light. For instance, the seed production plant may be subjected to supplemental far-red light for a further 15-60 minutes per day, preferably for a further 20-40 minutes after the irradiation with supplemental light having a shorter wavelength than the supplemental far-red light is concluded.

The light source for the supplemental light having a shorter wavelength than the supplemental far-red light may comprise one or more gas discharge light sources, which are commonly used low-pressure mercury vapor discharge lamps with phosphor coating. Alternatively, the light source for the supplemental light having a shorter wavelength than the supplemental far-red light may be a LED light source which emits light having the desired wavelength profile.

In one aspect, the supplemental light having a lower wavelength than the supplemental far-red light in the method of the present invention originates from an artificial light source emitting light having a wavelength in the range of 340 to 480 nm. Preferably, the supplemental light having a lower wavelength than the supplemental far-red light as used in the method of the present invention originates from an artificial light source emitting light having a wavelength in the range of 380-480. It was surprisingly found that the application of supplemental light in the range of 380-480 nm enhances the herein described effects of the application of supplemental far-red light.

In one aspect, the supplemental light having a lower wavelength than the supplemental far-red light in the method of the present invention originates from an artificial light source emitting light with an intensity of 5-200 μmol/m²/s. Preferably, the supplemental light having a lower wavelength than the supplemental far-red light in the method of the present invention originates from an artificial light source emitting light with an intensity of 10-200 μmol/m²/s, 15-200 μmol/m²/s, 20-200 μmol/m²/s, 25-200 μmol/m²/s, 30-200 μmol/m²/s, 35-200 μmol/m²/s, 40-200 μmol/m²/s, 50-200 μmol/m²/s, 60-200 μmol/m²/s, 70-200 μmol/m²/s, 80-200 μmol/m²/s, 90-200 μmol/m²/s, 5-190 μmol/m²/s, 10-190 μmol/m²/s, 15-190 μmol/m²/s, 20-190 μmol/m²/s, 25-190 μmol/m²/s, 30-190 μmol/m²/s, 35-190 μmol/m²/s, 40-190 μmol/m²/s, 50-190 μmol/m²/s, 60-190 μmol/m²/s, 70-190 μmol/m²/s, 80-190 μmol/m²/s, 90-190 μmol/m²/s, 100-190 μmol/m²/s, 5-180 μmol/m²/s, 10-180 μmol/m²/s, 15-180 μmol/m²/s, 20-180 μmol/m²/s, 25-180 μmol/m²/s, 30-180 μmol/m²/s, 35-180 μmol/m²/s, 40-180 μmol/m²/s, 50-180 μmol/m²/s, 60-180 μmol/m²/s, 70-180 μmol/m²/s, 80-180 μmol/m²/s, 90-180 μmol/m²/s, 5-170 μmol/m²/s, 10-170 μmol/m²/s, 15-170 μmol/m²/s, 20-170 μmol/m²/s, 25-170 μmol/m²/s, 30-170 μmol/m²/s, 35-170 μmol/m²/s, 40-170 μmol/m²/s, 50-170 μmol/m²/s, 60-170 μmol/m²/s, 70-170 μmol/m²/s, 80-170 μmol/m²/s, 90-170 μmol/m²/s, 5-160 μmol/m²/s, 10-160 μmol/m²/s, 15-160 μmol/m²/s, 20-160 μmol/m²/s, 25-160 μmol/m²/s, 30-160 μmol/m²/s, 35-160 μmol/m²/s, 40-160 μmol/m²/s, 50-160 μmol/m²/s, 60-160 μmol/m²/s, 70-160 μmol/m²/s, 80-160 μmol/m²/s, 90-160 μmol/m²/s, 5-150 μmol/m²/s, 10-150 μmol/m²/s, 15-150 μmol/m²/s, 20-150 μmol/m²/s, 25-150 μmol/m²/s, 30-150 μmol/m²/s, 35-150 μmol/m²/s, 40-150 μmol/m²/s, 50-150 μmol/m²/s, 60-150 μmol/m²/s, 70-150 μmol/m²/s, 80-150 μmol/m²/s, 90-150 μmol/m²/s, 5-140 μmol/m²/s, 10-140 μmol/m²/s, 15-140 μmol/m²/s, 20-140 μmol/m²/s, 25-140 μmol/m²/s, 30-140 μmol/m²/s, 35-140 μmol/m²/s, 40-140 μmol/m²/s, 50-140 μmol/m²/s, 60-140 μmol/m²/s, 70-140 μmol/m²/s, 80-140 μmol/m²/s, 90-140 μmol/m²/s, 5-130 μmol/m²/s, 10-130 μmol/m²/s, 15-130 μmol/m²/s, 20-130 μmol/m²/s, 25-130 μmol/m²/s, 30-130 μmol/m²/s, 35-130 μmol/m²/s, 40-130 μmol/m²/s, 50-130 μmol/m²/s, 60-130 μmol/m²/s, 70-130 μmol/m²/s, 80-130 μmol/m²/s, or 90-130 μmol/m²/s.

In one aspect, the present invention provides the use of far-red light irradiation of a seed producing plant of a day-neutral plant species for improving the quality of the plant seeds produced by said seed production plant. Accordingly, the present invention provides the use of far-red light irradiation of a seed producing plant of a day-neutral plant species for improving the germination ratio and/or the usable transplant ratio of the plant seeds produced by said seed production plant. In one aspect, the present invention provides the use of far-red light irradiation of a seed producing plant of a day-neutral plant species for improving the germination ratio of the plant seeds produced by said seed production plant. In one aspect, the present invention provides the use of far-red light irradiation of a seed producing plant of a day-neutral plant species for improving the usable transplant ratio of the plant seeds produced by said seed production plant.

Preferably, the far-red light used to irradiate a seed producing plant is further characterized as described herein above. In one aspect, accordingly, the seed production is exposed to supplemental far-red light resulting in a phytochrome stationary state (PSS) value of less than 0.88. Preferably, the seed production plant is exposed to supplemental far-red light resulting in a PSS value of less than 0.87, less than 0.86, less than 0.85, less than 0.84, less than 0.83, less than 0.82, less than 0.81, less than 0.80, less than 0.79, less than 0.78, less than 0.76, less than 0.75, less than 0.74, or most preferably of less than 0.73. In one aspect, the supplemental far-red light as used originates from an artificial far-red light source having a peak wavelength in a range of 700 to 800 nm. Preferably, the artificial far-red light source as used has a peak wavelength in a range of 700 to 790 nm, 700 to 780 nm, 700 to 770 nm, 700 to 760 nm, 700 to 750 nm, 700 to 780 nm, 700 to 780 nm, 710 to 800 nm, 710 to 790 nm, 710 to 780 nm, 710 to 770 nm, 710 to 760 nm, 710 to 750 nm, 720 to 800 nm, 720 to 790 nm, 720 to 780 nm, 720 to 770 nm, 720 to 760 nm, or 720 to 750 nm. In one aspect, the supplemental far-red light in the method of the present invention originates from an artificial far-red light source emitting far-red light with an intensity of 5-200 μmol/m²/s. In one aspect, the artificial far-red light source as used is emitting far-red light with an intensity of 10-200 μmol/m²/s, 15-200 μmol/m²/s, 20-200 μmol/m²/s, 25-200 μmol/m²/s, 30-200 μmol/m²/s, 35-200 μmol/m²/s, 40-200 μmol/m²/s, 50-200 μmol/m²/s, 60-200 μmol/m²/s, 70-200 μmol/m²/s, 80-200 μmol/m²/s, 90-200 μmol/m²/s, 5-190 μmol/m²/s, 10-190 μmol/m²/s, 15-190 μmol/m²/s, 20-190 μmol/m²/s, 25-190 μmol/m²/s, 30-190 μmol/m²/s, 35-190 μmol/m²/s, 40-190 μmol/m²/s, 50-190 μmol/m²/s, 60-190 μmol/m²/s, 70-190 μmol/m²/s, 80-190 μmol/m²/s, 90-190 μmol/m²/s, 100-190 μmol/m²/s, 5-180 μmol/m²/s, 10-180 μmol/m²/s, 15-180 μmol/m²/s, 20-180 μmol/m²/s, 25-180 μmol/m²/s, 30-180 μmol/m²/s, 35-180 μmol/m²/s, 40-180 μmol/m²/s, 50-180 μmol/m²/s, 60-180 μmol/m²/s, 70-180 μmol/m²/s, 80-180 μmol/m²/s, 90-180 μmol/m²/s, 5-170 μmol/m²/s, 10-170 μmol/m²/s, 15-170 μmol/m²/s, 20-170 μmol/m²/s, 25-170 μmol/m²/s, 30-170 μmol/m²/s, 35-170 μmol/m²/s, 40-170 μmol/m²/s, 50-170 μmol/m²/s, 60-170 μmol/m²/s, 70-170 μmol/m²/s, 80-170 μmol/m²/s, 90-170 μmol/m²/s, 5-160 μmol/m²/s, 10-160 μmol/m²/s, 15-160 μmol/m²/s, 20-160 μmol/m²/s, 25-160 μmol/m²/s, 30-160 μmol/m²/s, 35-160 μmol/m²/s, 40-160 μmol/m²/s, 50-160 μmol/m²/s, 60-160 μmol/m²/s, 70-160 μmol/m²/s, 80-160 μmol/m²/s, 90-160 μmol/m²/s, 5-150 μmol/m²/s, 10-150 μmol/m²/s, 15-150 μmol/m²/s, 20-150 μmol/m²/s, 25-150 μmol/m²/s, 30-150 μmol/m²/s, 35-150 μmol/m²/s, 40-150 μmol/m²/s, 50-150 μmol/m²/s, 60-150 μmol/m²/s, 70-150 μmol/m²/s, 80-150 μmol/m²/s, 90-150 μmol/m²/s, 5-140 μmol/m²/s, 10-140 μmol/m²/s, 15-140 μmol/m²/s, 20-140 μmol/m²/s, 25-140 μmol/m²/s, 30-140 μmol/m²/s, 35-140 μmol/m²/s, 40-140 μmol/m²/s, 50-140 μmol/m²/s, 60-140 μmol/m²/s, 70-140 μmol/m²/s, 80-140 μmol/m²/s, 90-140 μmol/m²/s, 5-130 μmol/m²/s, 10-130 μmol/m²/s, 15-130 μmol/m²/s, 20-130 μmol/m²/s, 25-130 μmol/m²/s, 30-130 μmol/m²/s, 35-130 μmol/m²/s, 40-130 μmol/m²/s, 50-130 μmol/m²/s, 60-130 μmol/m²/s, 70-130 μmol/m²/s, 80-130 μmol/m²/s, or 90-130 μmol/m²/s. In one aspect, the seed production plant is subjected supplemental far-red light for 1-20 hrs per day. Preferably, the seed production plant in the method of the present invention is subjected supplemental far-red light for 2-20 hrs per day, 3-20 hrs per day, 4-20 hrs per day, 5-20 hrs per day, 6-20 hrs per day, 7-20 hrs per day, 8-20 hrs per day, 1-19 hrs per day, 2-19 hrs per day, 3-19 hrs per day, 4-19 hrs per day, 5-19 hrs per day, 6-19 hrs per day, 7- 19 hrs per day, 8-19 hrs per day, 1-18 hrs per day, 2-18 hrs per day, 3-18 hrs per day, 4-18 hrs per day, 5-18 hrs per day, 6-18 hrs per day, 7-18 hrs per day, or most preferably 8-18 hrs per day.

Preferably, the seed producing plant as irradiated with far-red light is as described in more detail herein.

### Methods for Producing Plant Seeds

In one aspect, the present invention provides a method for producing plant seeds comprising growing fruit on a seed production plant that is subjected to supplemental far-red light and obtaining the plant seeds from the ripened fruit, wherein said seed production plant is of a day-neutral plant species. In one aspect, the present invention provides a method for producing plant seeds comprising growing fruit on a seed production plant that is subjected to an effective amount of supplemental far-red light and obtaining the plant seeds from the ripened fruit, wherein said seed production plant is of a day-neutral plant species.

In one aspect, the method for producing plant seeds according to the present invention further comprises growing the seed production plant in the presence of supplemental far-red light before fertilization as further described herein above.

In one aspect, the seed production plant in the method for producing plant seeds according to the present invention is exposed to supplemental far-red light resulting in a phytochrome stationary state (PSS) value of less than 0.88 as further described herein above in the context of the method of treating a plant according to the present invention.

In one aspect, the supplemental far-red light in the method for producing plant seeds according to the present invention originates from an artificial far-red light source having a peak wavelength in a range of 700 to 800 nm as further described herein above in the context of the method of treating a plant according to the present invention.

In one aspect, the supplemental far-red light in the method for producing plant seeds according to the present invention originates from an artificial far-red light source emitting far-red light with an intensity of 5-200 μmol/m²/s as further described herein above in the context of the method of treating a plant according to the present invention.

In one aspect, the artificial far-red light source in the method for producing plant seeds according to the present invention is a LED light source as further described herein above in the context of the method of treating a plant according to the present invention as further described herein above in the context of the method of treating a plant according to the present invention.

In one aspect, the seed production plant in the method for producing plant seeds according to the present invention is subjected to supplemental far-red light for 1-20 hrs per day as further described herein above in the context of the method of treating a plant according to the present invention.

In one aspect, the seed production plant in the method for producing plant seeds according to the present invention is a vegetable plant, preferably a carrot, corn salad, cucumber, eggplant, melon, pepper, squash, tomato or watermelon plant, most preferably a cucumber, pepper or tomato plant as further described herein above in the context of the method of treating a plant according to the present invention.

In one aspect, the seed production plant in the method for producing plant seeds according to the present invention is an inbred plant as further described herein above in the context of the method of treating a plant according to the present invention.

In one aspect, the seed production plant in the method for producing plant seeds according to the present invention is an F1 hybrid parental line plant as further described herein above in the context of the method of treating a plant according to the present invention.

In one aspect, the seed production plant in the method for producing plant seeds according to the present invention is a male sterile plant as further described herein above in the context of the method of treating a plant according to the present invention.

In one aspect, the plant seeds produced by the seed production plant in the method for producing plant seeds according to the present invention are F1 hybrid plant seeds as further described herein above in the context of the method of treating a plant according to the present invention.

In one aspect, the seed production plant in the method for producing plant seeds according

to the present invention is additionally subjected to supplemental light having a shorter wavelength than the supplemental far-red light as further described herein above in the context of the method of treating a plant according to the present invention.

In one aspect, the supplemental light having a lower wavelength than the supplemental far-red light in the method for producing plant seeds according to the present invention originates from an artificial light source emitting light having a wavelength in the range of 340 to 480 nm as further described herein above in the context of the method of treating a plant according to the present invention.

In one aspect, the supplemental light having a lower wavelength than the supplemental far-red light in the method for producing plant seeds according to the present invention originates from an artificial light source emitting light with an intensity of 5-200 μmol/m²/s as further described herein above in the context of the method of treating a plant according to the present invention.

One step of the method for producing plant seeds according to the present invention comprises growing fruit on a seed production plant. The method for producing plant seeds of the present invention accordingly does not encompass the steps of sexually crossing the whole genomes of plants and of subsequently selecting plants. The method for producing plant seeds of the present invention therefore can also be defined as a method for growing plant seeds comprising growing a seed production plant in the presence of an effective amount of supplemental far-red light, preferably after fertilization and/or during fruit development.

The present invention accordingly provides a method for producing plant seeds comprising the steps of: (a) providing a fertilized seed production plant; (b) subjecting the seed production plant to an effective amount of supplemental far-red light; and (c) obtaining the plant seeds from the ripened fruit, wherein said seed production plant is of a day-neutral plant species.

The method for producing plant seeds of the present invention comprises that the plant seeds are obtained from ripened fruit. Ripened fruit is fruit that is capable of producing sufficiently matured seeds. Therefore, the fruit can be harvested from the seed production plant and opened to collect the seeds. The ripened fruit may be harvested when they still comprise a certain amount of immature or semi-mature seeds, but it is preferred that the ripened fruits are mature or even over-mature since then they will comprise a higher percentage of mature seed. Thus, in one aspect the plant seeds are obtained from the ripened fruit when the majority of the comprised seeds are mature, i.e. to maximize mature seed yield. Thus in the event that the ripened fruit is from a plant species producing edible fruits, the plant seed may be obtained from the ripened fruit when said fruit is at a ripening stage when they are not marketable anymore for human consumption as it would be considered as having a too short shelf-life or being over-mature (softening of the fruit flesh)

The obtained plant seeds can be treated by one or more methods as described herein. Alternatively, mature seeds can be separated from the other seeds, so that a high percentage of seeds is mature (e.g. at least 80%, 90%, 95%, 97%, 98%, 99% or 100%), which can then be treated by one or more treatments methods and eventually packaged for sale.

Mature seeds can be separated from less mature seeds and/or immature seeds using different methods known to the skilled person. In one aspect the harvested seeds are placed in water, as the mature seeds are heavier than the less mature and white immature seeds and will sink (while less mature and immature seeds float). This way the mature seeds can easily be collected.

The method for producing plant seeds of the present invention may further comprise that the obtained plant seeds are subjected to a seed treatment after obtaining the seeds from the ripened fruit. Treating the seed includes, but is not limited to, one or more of the following: cleaning, washing, drying, hydrating, disinfection, selection for viability, seed priming, seed coating (e.g. film coating), seed pelleting as defined herein, adding a seed treatment formulation (such as a composition comprising at least one insecticidal, a fungicidal, acaricidal or nematicidal compound, or a plant growth regulator or a biological control agent), and/or combinations of such treatments. For example, in one aspect the seeds of the plant may in a first step be hydrated, in a second step be dried and in a third step be treated with a seed treatment formulation. Methods of treating the seed are disclosed for instance in WO2008/107097A1, which is incorporated herein by reference.

In one aspect, the present invention provides a method for improving the quality of plant seeds produced by a seed production plant comprising growing said plant in the presence of an effective amount of supplemental far-red light, preferably after fertilization and/or during fruit development, wherein said seed production plant is of a day-neutral plant species. In one aspect, the present invention provides a method for improving the germinability of plant seeds produced by a seed production plant comprising subjected said seed production plant to an effective amount of supplemental far-red light. In one aspect, the present invention provides a method for producing plant seeds having an improved germinability comprising growing fruit on a seed production plant that is subjected to an effective amount of supplemental far-red light and obtaining the plant seeds from the ripened fruit.

When referring herein to “the method for producing plant seeds according to the present invention”, it is not only referred to the method for producing plant seeds comprising growing fruit on a seed production plant that is subjected to supplemental far-red light and obtaining the plant seeds from the ripened fruit, but it is also referred to the method for improving the quality and/or germinability of plant seeds produced by a seed production plant comprising growing said plant in the presence of an effective amount of supplemental far-red light, preferably after fertilization and/or during fruit development and to the method for producing plant seeds having an improved germinability comprising growing fruit on a seed production plant that is subjected to an effective amount of supplemental far-red light and obtaining the plant seeds from the ripened fruit.

### EXAMPLES

### Example 1

### Effect of Far-Red Light on Hybrid Tomato Plants

Hybrid tomato plants were grown in a winter season with supplemental light. This was applied with SONT light and two intercrop LED light bars (Philips). The intensity of light was 100 μmol/m²/s for SONT and 100 μmol/m²/s for the intercrop light bars. Far-red was given with top LED's from Philips with an intensity of 30 μmol/m²/s. The amount of light and the duration was progressively increased from planting until the crop was in full production. In full production the light was used for 18 hours/day. Far-red was used at the same hours as SONT, with the exception that far-red was given 30 minutes longer at the end of the day. The treatment started four days after planting the young plants on the rockwool sabs in the greenhouse.

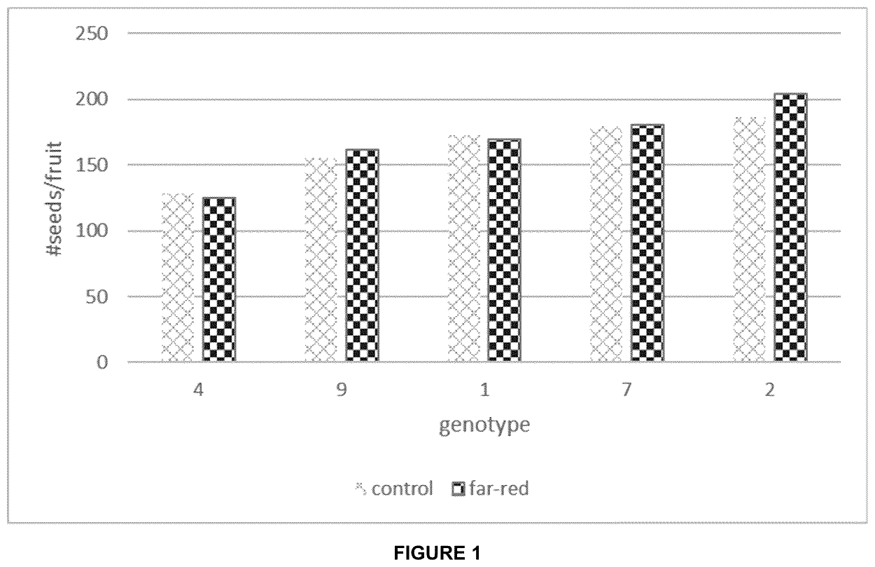

From 11 hybrids fruits have been harvested on 106, 114, 120, 127 and 134 days after planting, from which seeds have been extracted. For 5 hybrids the number of seeds per fruit has been determined and there was no statistical difference between control conditions and the far-red treatment (FIG. 1).

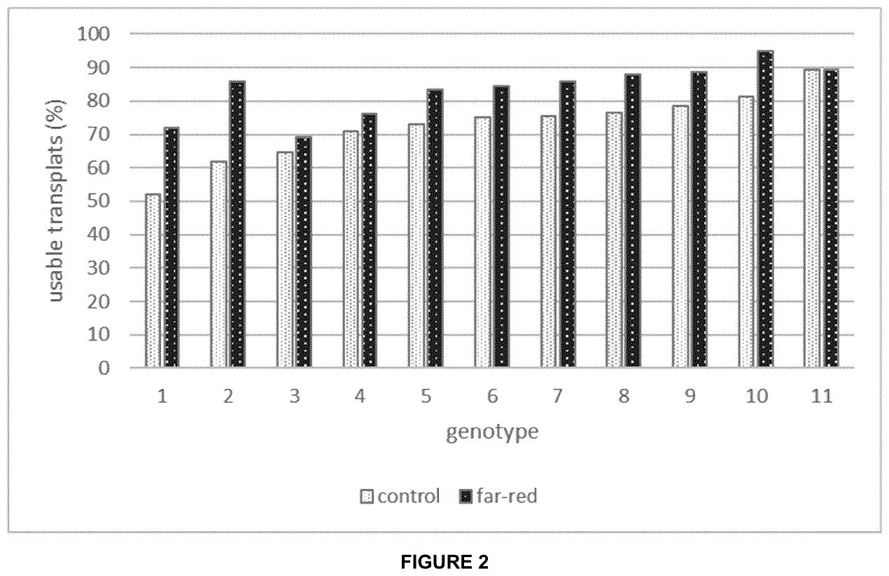

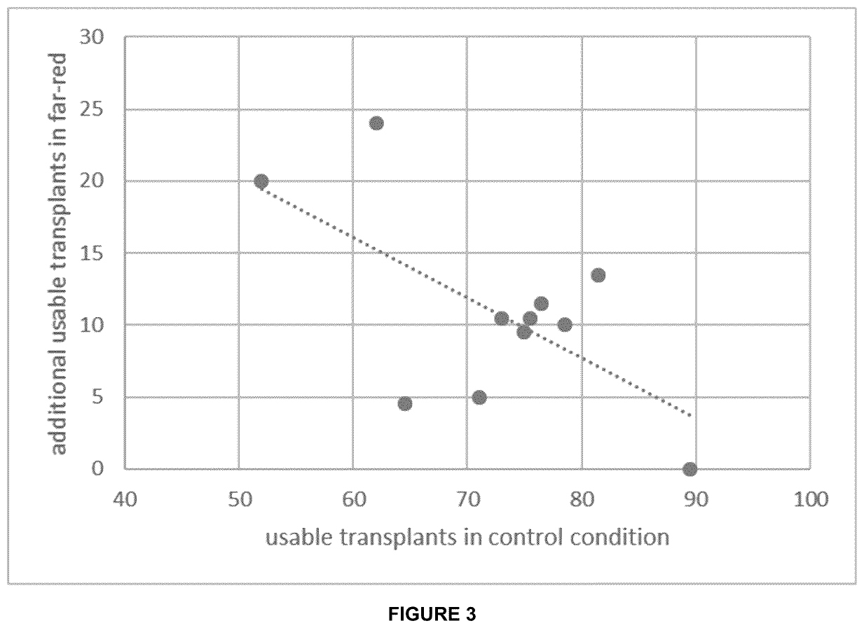

The seeds extract has been used in a young plant assay. The percentage usable transplants have been counted from the different seed batches. In some cases, there was no effect on the percentage usable transplants, in most cases there was a positive effect due to far-red (FIG. 2). Moreover, it will be more difficult to improve the percentage usable transplants from seed batches that are already giving a high percentage usable transplants. When plotting the additional usable transplants from far-red compared to the control conditions (FIG. 3) it is clear that the largest positive effects are measured when the control conditions give a low percentage usable transplants.

In conclusion with the same amount of seeds/fruit a better seed quality was obtained from plants grown with additional far-red.

### Example 2

### Effect of Far-Red Light on Parental Lines for Producing Hybrid Tomato Seeds

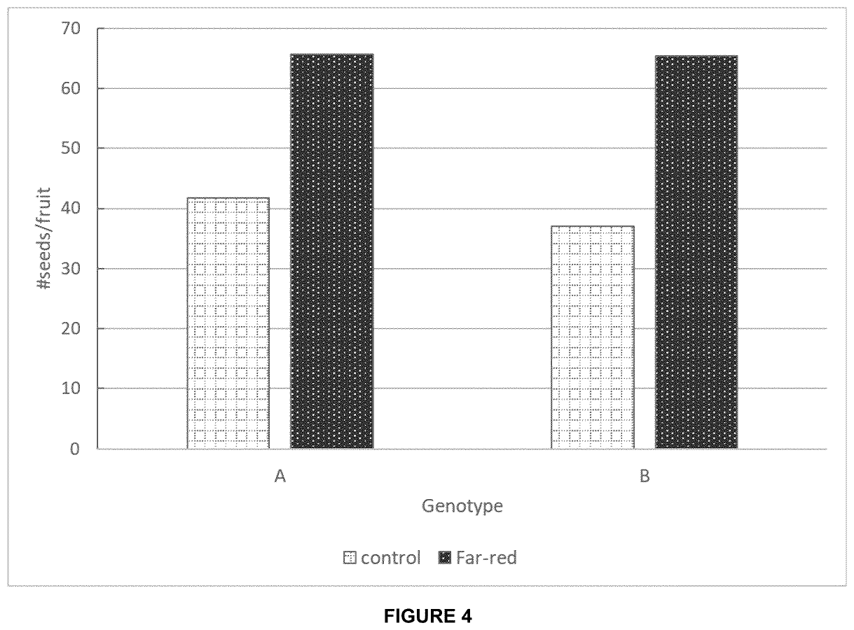

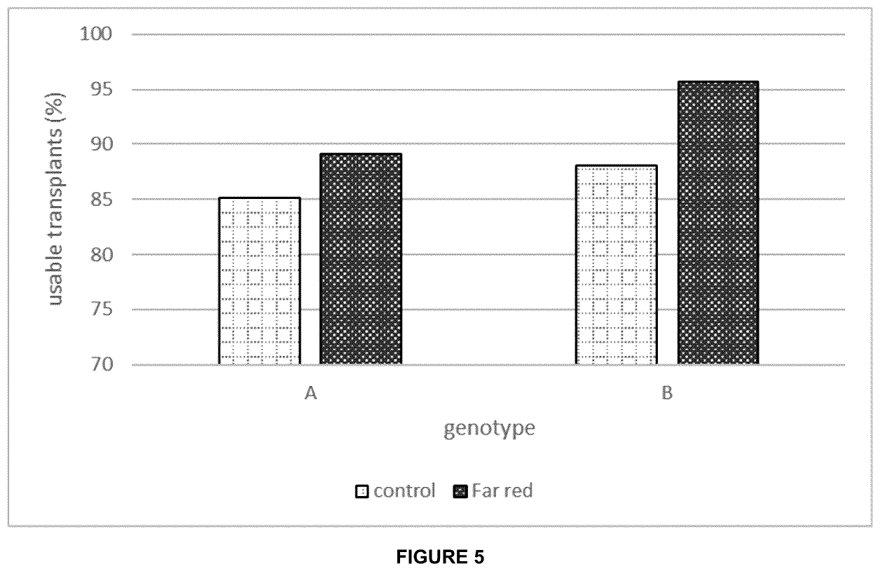

To test the effect of far-red on the production of F1 hybrid seeds, plants have been grown in the same setup as in example 1, but in a different year. The mother lines were grown after transplanting in control conditions or with the addition of far-red top light. The pollen came from plants grown in a different control greenhouse. After emasculation and pollination, the fruits have been harvested on 3-April, 10-April and 17-April when fully mature. Seeds were extracted from the fruits. The number of seeds per fruit was higher for both genotypes with the addition of far-red compared to control conditions (FIG. 4). The percentage useable transplants were also higher from plants grown with the addition of far-red (FIG. 5). To conclude the addition far-red during the production of F1 seeds has a positive effect on the amount of seeds/fruit and on the percentage usable transplants.

### Example 3

### Effect of Different Light Spectra in Tomato

To determine the boundaries of the far-red effect, we decided to apply different amounts of far-red and in two different background spectrums.

It is hypothesized that the far-red effect is working via the phytochrome sensing mechanism. To estimate the effect of different light spectra you can calculate the phytochrome stationary state (PSS). The whole absorption spectra of the two states of phytochrome is taken into account (Sager et al. (1988) Trans. ASAE31, 1882-1889.doi:10.13031/2013.30952). Two hybrid tomato genotypes have been grown under light conditions resulting in a PSS value of 0.88, 0.80 and 0.72 with blue and red LED's or with blue, red and white LED's (Table 1). Seeds have been harvested and the germination has been determined at the seedling stage. It is clear that a lower PSS value has a positive effect on the percentage germinated seeds (table 2). The background light does not have an influence. Moreover, this supports the hypothesis that the phytochrome sensing mechanism is playing a crucial role. And the amount of far-red applied can vary depending on the other light colors, as long as a lower PSS value is obtained.

TABLE 1
Composition of the light in the different treatments on
a relative scale. The PAR light (400-700 nm) is 100%

| | PSS | | | | | |
|---|---|---|---|---|---|---|
| color | BR 0.72 | BR 0.80 | BR 0.88 | BRW 0.72 | BRW 0.80 | BRW 0.87 |
| UV (300-400 nm) | 1 | 1 | 1 | 1 | 1 | 1 |
| Blue (400-500 nm) | 21 | 20 | 21 | 21 | 21 | 20 |
| Green (500-600 nm) | 1 | 1 | 1 | 16 | 16 | 16 |
| Red (600-700 nm) | 78 | 79 | 78 | 63 | 63 | 64 |
| Far red (700-800 nm) | 66 | 32 | 1 | 53 | 25 | 1 |

TABLE 2
The percentage germinated seeds from plants grown at 3 different phytochrome
stationary state (PSS) values and two different background lights.

| | PSS | | | | | |
|---|---|---|---|---|---|---|
| Genotype | RB 0.72 | RB 0.8 | RB 0.88 | RBW 0.72 | RBW 0.8 | RBW 0.88 |
| A | 0.83 | 0.76 | 0.52 | 0.87 | 0.79 | 0.52 |
| C | 0.84 | 0.83 | 0.62 | 0.81 | 0.75 | 0.64 |
| Grand Total | 0.83 | 0.80 | 0.57 | 0.84 | 0.77 | 0.59 |

### Example 4

### Cucumber

To explore the effects of far-red and the PSS values in cucumber an experiment was performed in a phytotron with 4 different light spectra and 2 PSS values; see Table 3 with the light compositions as used.

TABLE 3
Composition of the light in the different individual growth zones.

| % μmol (PAR = 100%) | Zone 1 | Zone 2 | Zone 3 | Zone 4 |
|---|---|---|---|---|
| % Blue in PAR | 11.1% | 11.0% | 19.0% | 19.0% |
| % Cyane in PAR | 5.2% | 5.2% | 28.2% | 28.2% |
| % Red in PAR | 83.7% | 83.8% | 52.8% | 52.8% |
| % Far-red in PAR | 6.0% | 30.1% | 16.4% | 1.5% |
| PSS | 0.86 | 0.80 | 0.80 | 0.86 |

F1 hybrid seeds have been produced for a representative cucumber variety. This hybrid seed variety has under control condition (zone 1) a much lower seedling vitality (usable transplant percentage) and this is increased substantially when the PSS values has been lowered (zone 2 and zone 3).

1. A method for treating a seed production plant of a day-neutral plant species comprising subjecting said seed production plant to supplemental far-red light.

2. The method according to claim 1, further comprising subjecting the seed production plant to supplemental far-red light during fruit development.

3. The method according to claim 1, wherein the seed production plant is exposed to supplemental far-red light resulting in a phytochrome stationary state (PSS) value of less than 0.88.

4. The method according to claim 1, wherein the supplemental far-red light originates from an artificial far-red light source having a peak wavelength in a range of 700 to 800 nm.

5. The method according to claim 1, wherein the supplemental far-red light originates from an artificial far-red light source emitting far-red light with an intensity of 5-200 μmol/m²/s.

6. The method according to claim 4, wherein the artificial far-red light source is a LED light source.

7. The method according to claim 1, wherein the seed production plant is subjected to supplemental far-red light for 1-20 hrs per day.

8. The method according to claim 1, wherein the seed production plant is a vegetable plant.

9. The method according to claim 1, wherein the seed production plant is an inbred plant.

10. The method according to claim 1, wherein the seed production plant is an F1 hybrid parental line plant.

11. The method according to claim 1, wherein the seed production plant is a male sterile plant.

12. The method according to claim 1, wherein the seed production plant produces F1 hybrid plant seeds.

13. The method according to claim 1, wherein the seed production plant is additionally subjected to supplemental light having a shorter wavelength than the supplemental far-red light.

14. The method according to claim 13, wherein the supplemental light having a lower wavelength than the supplemental far-red light originates from an artificial light source emitting light having a wavelength in the range of 340 to 480 nm.

15. The method according to claim 13, wherein the supplemental light having a lower wavelength than the supplemental far-red light originates from an artificial light source emitting light with an intensity of 5-200 μmol/m²/s.

16. A method for improving the quality of plant seeds produced by a seed production plant comprising growing said plant in the presence of an effective amount of supplemental far-red light, wherein said seed production plant is of a day-neutral plant species.

17. The method according to claim 1, wherein the seed production plant is a carrot, corn salad, cucumber, eggplant, melon, pepper, squash, tomato or watermelon plant.

18. The method according to claim 1, wherein the seed production plant is a cucumber, pepper, or tomato plant.

19. The method according to claim 16, wherein the supplemental far-red light is applied after fertilization and/or during fruit development of the seed production plant.
